(19) United States
(12) Patent Application Publication
(10) Pub. No.: US 2013/0048233 A1
(43) Pub. Date: Feb. 28, 2013

(54) Blind Having Cord Shrouds

(71) Applicant: Tzong-Fu Lin, Taipei (TW)

(72) Inventor: Tzong-Fu Lin, Taipei (TW)

(73) Assignee: WHOLE SPACE INDUSTRIES LTD, Taipei (TW)

(21) Appl. No.: 13/214,515

(22) Filed: Aug. 22, 2011

(51) Int. Cl. E06B 9/303

(52) U.S. Cl. 160/168.1 R

(57) ABSTRACT

A blind includes a plurality of ladders extending from a headrail. Slats are supported on the ladders. Lift cords extend from the headrail. Each lift cord is adjacent to one of the ladders and extends to the lowermost slat of the slats. Cord shrouds are also included. Each of the cord shrouds enclose a portion of one of the lift cords that extends from the headrail to a position adjacent to the lowermost slat. Each cord shroud is attached to the ladder which is adjacent the lift cord enclosed by the cord shroud. Preferably, each cord shroud is either a rail of the ladder or is otherwise attached to a ladder at spaced apart locations to prevent the lift cord enclosed by the cord shroud from being pulled away from the slats to form a loop of a size capable of posing a danger to a small child.

### FIELD OF INVENTION

The present invention relates to window coverings, such as blinds, venetian blinds, or other types of blinds.

### BACKGROUND OF THE INVENTION

On occasion, children have been able to get behind a lowered Roman shade, pull a lift cord to form a loop and become entangled in the loop. If the lift cord is around the child's neck and the child falls, the cord could act as a noose and strangle the child. Children have also become entangled within lift cords of venetian blinds. Reports of such incidents have prompted at least one major retailer to issue a recall of one product line of Roman shades and the United States Consumer Product Safety Commission (CPSC) has issued a warning about the danger of child entanglement with cords of window coverings. In addition the CPSC has issued guidelines, rules and proposed rules that require window covering manufacturers to make shades with inaccessible cords or to construct the window covering product in a manner so that a child cannot form a loop in a cord which is large enough, greater than 8 inches in diameter, for a child's head to fit through the loop.

The art has developed various types of child safety devices that are intended to prevent deaths of children who become entangled in lift cords. For instance, U.S. Pat. Nos. 7,318,251, 7,261,138, 7,225,850, 7,117,918, 7,086,446, 7,000,672, 6,948,546, 6,918,425, 6,860,312, 6,637,493, 6,484,787, 6,431,248, 5,630,458, 5,533,559 and 4,909,298 and U.S. Patent Application Publication Nos. 2008/0110581, 2007/0023149 and 2006/0144526 disclose child safety devices for blinds. U.S. Pat. Nos. 5,495,883 and 5,613,540 discloses cord shrouds used on the front of a blind. Child safety devices may be configured to keep the lift cords taught so that the cords cannot be pulled away from the window covering material and form a noose or release the cord from the shade when a child becomes entangled in the shade.

Other examples of child safety devices may be appreciated from my U.S. patent application Ser. No. 13/185,629, which was filed on Jul. 19, 2011. This application discloses shrouds that may be used in connection with window coverings such as Roman shades, pleated shades, Venetian blinds, and other window coverings with cords.

A new window covering is needed to replace or change conventional blind designs to help prevent the entanglement of children within exposed cords. Preferably, such a design prevents loops from being formed such that children cannot become entangled with lift cords while also covering or enclosing lift cords of the blind.

### SUMMARY OF THE INVENTION

A blind may include a headrail, a plurality of ladders extending from the headrail, a plurality of slats supported on the ladders, a plurality of lift cords extending from the headrail, and a plurality of cord shrouds. The ladders may each comprise a column of rungs extending between two spaced apart rails. The slats may include a lowermost slat that is positioned furthest from the headrail. Each lift cord is adjacent to one of the ladders and extends to the lowermost slat. Each of the cord shrouds encloses a portion of one of the lift cords that extends from the headrail to a position adjacent to the lowermost slat and is also attached to the ladder that is adjacent the lift cord enclosed by the cord shroud.

The slats of the blind may be composed of any of a number of suitable materials. For instance, slats may be composed of metal or plastic.

Each of the cord shrouds may be attached to a respective one of the ladders at spaced apart positions. Each cord shroud may be attached to one of the rails of the ladder to which it is attached or may be attached to both rails. Each cord shroud could alternatively be attached to one or more rungs of the ladder to which it is attached or be attached to all the rungs of the ladder. In yet other alternatives, each cord shroud could be attached to one or more of the rails and also be attached to one or more of the rungs of the ladder to which it is attached.

A plurality of fasteners may be used to attach the cord shrouds to at least one of the rails of the ladder, one or more of the rungs of the ladder, or both the rails and rungs of the ladder to which the cord shroud is attached. The fasteners may be loops, rings, adjustable loops, zip ties, other fasteners, or fastening mechanisms such as sewn connections or other types of formed connections.

In some embodiments of the blind, the lift cords and cord shrouds may extend through the slats. In other embodiments, the lift cords and shrouds may extend adjacent to an edge of each of the slats without passing through the slats.

Embodiments of the blind may include a bottom rail, which may be below the lowermost slat. The portion of each of the lift cords may extend to that bottom rail. Additionally, each cord shroud may extend to the bottom rail.

In some embodiments of the blind, the cord shrouds may be attached to the headrail at one end and have an opposite end attached to the lowermost slat or bottom rail. For example, a first end of each cord shroud may be attached to the headrail and a second end opposite the first end may be attached to the bottom rail or lowermost slat. The first end of each cord shroud may be an upper end and the second end of each cord shroud may be a lower end.

In some embodiments, a blind may include a first rail, a plurality of ladders extending from the first rail, a plurality of slats, and a plurality of lift cords extending from the first rail. Each lift cord may be adjacent to one of the plurality of ladders and extend to the lowermost slat of the slats. Each of the ladders may be comprised of at least one cord shroud and a column of rungs attached to the at least one cord shroud. The rungs support the slats. The at least one cord shroud encloses a portion of one of the lift cords that extends from the first rail to a position adjacent to the lowermost slat.

In some embodiments, the ladder may be comprised of only one cord shroud and is further comprised of an elongated flexible member that extends from the first rail to a position adjacent to the lowermost slat. The rungs of the ladder may extend between the flexible elongated member and the cord shroud to support the slats. The at least one cord shroud is attached to the flexible elongated member by the rungs such that the portion of the lift cord enclosed by the cord shroud is prevented from being pulled away from the slats to form a loop having a diameter of greater than six inches.

Embodiments of the blind may also include a lift cord control mechanism, such as a cord lock, spring motor, or motor that is configured to control movement of the lift cords for lowering and raising the blind. The lift cord control mechanism may be attached to the lift cords so that actuation of the mechanism permits or causes movement of the lift cords for raising and lowering of the blind. Additionally, a tilt mechanism may be attached o the ladders so that the slats may be moved from an open position to a closed position. A separate actuation mechanism may be attached to the tilt mechanism for tilting of the slats.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of my window covering are shown in the accompanying drawings and certain present preferred methods of practicing the same are also illustrated therein. It should be appreciated that like reference numbers used in the drawings may identify like components.

FIG. 1 is front perspective view of a first present preferred embodiment of a Venetian blind in a lowered, or extended position. The slats are shown tilted in a closed position.

FIG. 2 is a front perspective view of the first present preferred embodiment of the blind shown in an extended, or lowered, position. The slats are shown in an open position.

FIG. 3 is a front perspective view of the first present preferred embodiment of the blind with the window covering material in a retracted position.

FIG. 4 is a fragmentary side view of the first present preferred embodiment of the blind illustrating a slat positioned on a rung of a ladder and a cord shroud attached to the ladder and the cord shroud and lift cord passing through holes in the slats.

FIG. 5 is a fragmentary side view similar to FIG. 4 illustrating an alternative embodiment of the blind in which slats may be positioned on the rungs of a ladder, a cord shroud may be attached to the ladder and the cord shroud and lift cord may pass along an edge of each of the slats.

FIG. 6 is a fragmentary side view similar to FIGS. 4 and 5 illustrating another alternative embodiment of the blind in which, for each slat, the slat may be positioned on rungs of a ladder and a cord shroud may extend through the gap defined between the rungs of the ladder while also passing through holes in the slats. A portion of the slat illustrated in FIG. 6 is cut away to better illustrate the cord shroud passing through the slat.

FIG. 7 is a fragmentary side view illustrating yet another alternative embodiment of the blind in which a cord shroud functions as a rail for a ladder.

FIG. 8 is a fragmentary view similar to FIG. 7 illustrating another embodiment of the blind in which a ladder has one rail that is a cord shroud and another rail that is composed of a flexible elongated member such as a cord or tape material.

### DESCRIPTION OF PRESENT PREFERRED EMBODIMENTS

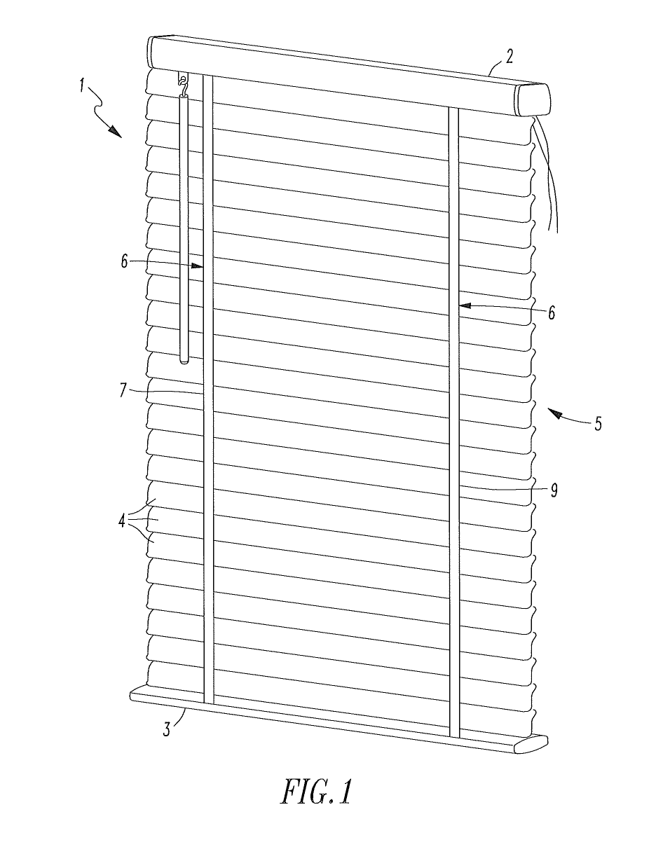

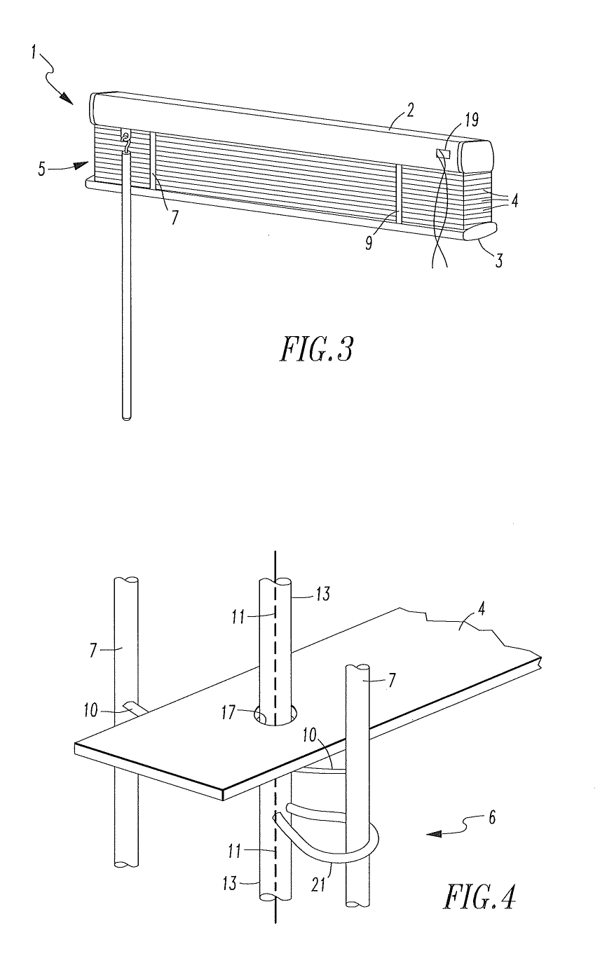

Referring to FIGS. 1-4, a blind 1 may include a headrail 2, a bottom rail 3, and window covering material 5 that extends between the headrail 2 and the bottom rail 3. The window covering material 5 may include slats 4 that are positioned on rungs of a plurality of ladders 6. The slats may be composed of metal, such as aluminum, or may be composed of plastic.

A cord lock 19 or other lift cord control mechanism may be attached to the headrail to control movement of lift cords that extend from the headrail 2 to the bottom rail 3. The lift cords may pass through the window covering material 5 by passing through holes in the slats 4 or may pass alongside the window covering material 5 by passing alongside an edge of each slat. It should be understood that alternative embodiments of the blind that do not utilize a bottom rail may have the lift cords extend to the lowermost slat of the window covering material.

The lift cords may be wound and unwound from a shaft in the headrail or be wound and unwound from one or more spools positioned in the headrail. Winding of the lift cords raises the blind, or retracts the window covering material. Unwinding of the lift cords extends the window covering material, or lowers the blind. Lift cords may be lifting tape, cord material, elongated straps having a width of between 1 and three inches, or may be other flexible elongated members.

The ladders 6 may include a first ladder and a second ladder. The first ladder may have first rails 7 and rungs 10 that extend between the pair of first rails 7. The first rails 7 may include a front rail positioned on the front face of the window covering material and a rear rail positioned on the rear face of the window covering material.

The second ladder may have second rails 9 and rungs that extend between the pair of second rails 9. One second rail may be positioned on the front face of the window covering material and the other second rail may be on the rear face of the window covering material.

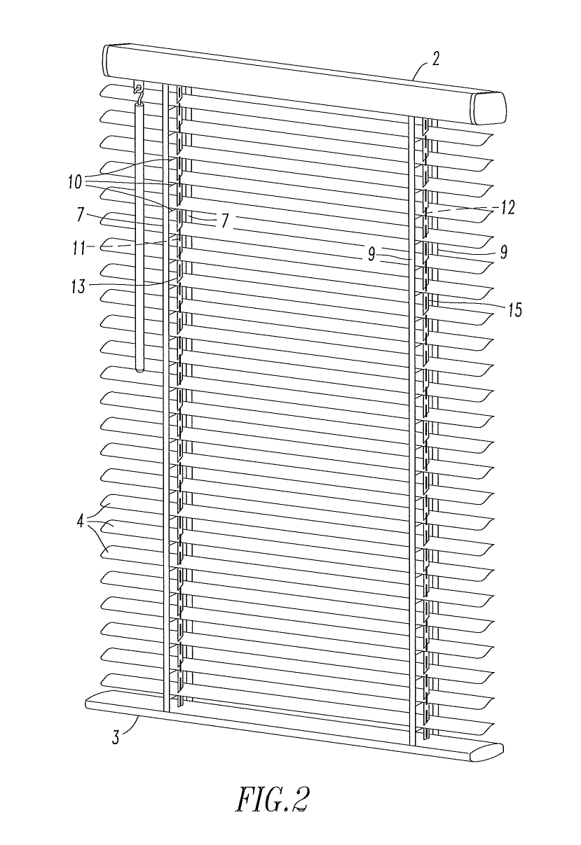

The rungs of the ladders support the slats 4. The ladders may be attached to a tilt mechanism located in or attached to the headrail that is actuated by a tilt rod or other actuation device so that the ladders may be moved to tilt the slats 4 from a closed position, as shown in FIG. 1 to an open position, as shown in FIG. 2.

The rails 7, 9 of the ladders may be cords, tape, or portions of cord material. The rails could also be comprised of other types of flexible elongated members. The rungs of each ladder may be portions of a cord, one or more strands of cord, segments of tape, or other material which is known in the art.

The portion of each lift cord that extends out of the headrail 2 and to the bottom rail 3 is enclosed by a cord shroud. For example, a first lift cord 11 is enclosed by a first cord shroud 13 and a second lift cord 12 is enclosed by a second cord shroud 15. The cord shrouds may be series of webs extending between spaced apart rungs to define a generally tubular structure. As another example, each cord shroud may be a tubular cloth structure or tubular structure having a mesh surface. In alternative designs, the cord shrouds may be spiral structures defining an aperture through which a portion of a lift cord passes. The cord shrouds may be composed of a cloth material, mesh material, or interwoven filaments. The cord shrouds may fully enclose the portion of the lift cord or, alternatively, may substantially enclose a lift cord.

Each of the cord shrouds may have a top end attached to the headrail 2 and a bottom end attached to the bottom rail 3. In embodiments that do not have a bottom rail 3, the bottom end of the cord shroud may be attached to the lowermost slat.

The cord shrouds are also attached to the ladders of the blind 1. For example, the cord shrouds for each lift cord may be attached to the ladder adjacent to that lift cord. The cord shroud may be attached to the ladder at spaced apart locations by loops, adjustable loops, adjustable zip ties, zip ties, rings, sewn connections, sewn connectors, or other fasteners or fastening mechanisms. Each cord shroud may be attached to the one or both rails of a ladder, to one or more rungs of the ladder, or to all the rungs of the ladder. Of course, a cord shroud could also be attached to at least one rail of the ladder and at least some of the rungs of the ladder as well.

Referring to FIG. 4, each cord shroud may be attached to a rail of the respective ladder to which the cord shroud is adjacent. For instance, the first cord shroud 13 that encloses a portion of the first lift cord 11 that extends from the headrail 2 to the bottom rail 3 may be attached to a rail 7 of the ladder adjacent to that cord shroud. Loops 21 may extend from the first cord shroud 13 to the rail 7. The loops 21 may be spaced apart by a predetermined distance to provide a number of different locations of attachment to the rail 7. For instance, the loops 21 may each be 4 inches, 5 inches, or 6 inches away from a loop that is immediately below or above that loop. As another example, the loops 21 may be positioned to attach the cord shroud to a junction of a rung and a rail on a periodic basis, such as having such a connection formed on the rail at every other rung. Preferably, the attachment locations are positioned to prevent the cord shroud from being pulled away from the slats 4 to form a loop of over six inches in diameter or over eight inches in diameter.

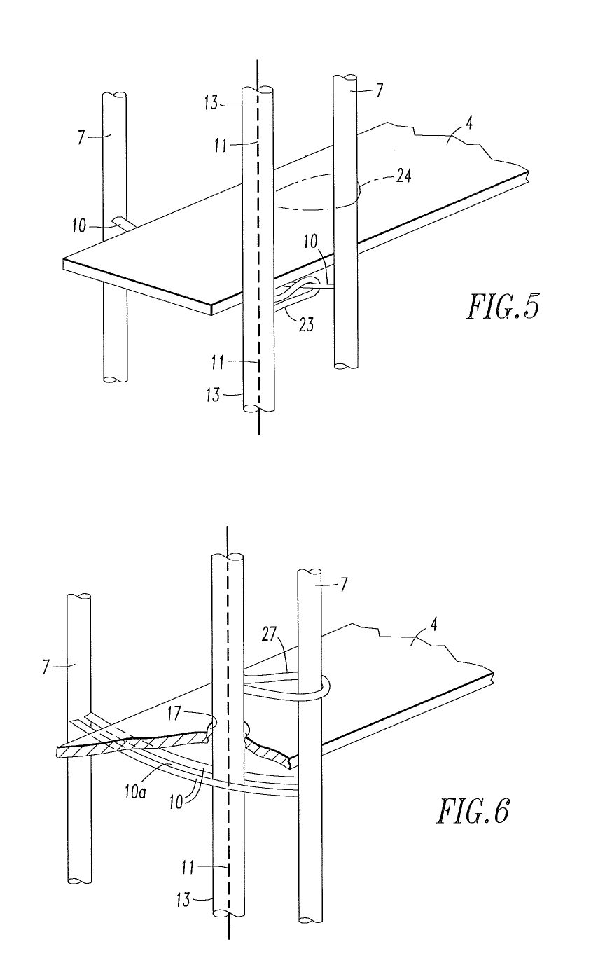

As may be appreciated from FIG. 4, the cord shrouds and lift cords may pass through each of the slats by passing through holes 17 in the slats. Alternatively, the cord shrouds and lift cords may pass adjacent to an edge of the slats or along an edge of the slats, as may be appreciated from FIG. 5. For such embodiments, loops 23 may extend from the cord shroud to rungs 10 of the ladder adjacent that cord shroud. Additionally, loops or rings 24 may extend from the cord shroud to attach the cord shroud to a rail of the ladder at different locations. As discussed above, the locations at which the cord shroud is attached to the ladder are spaced apart to prevent the formation of a loop that may pose an entanglement danger to small children.

In yet another alterative shown in FIG. 6, the cord shroud 13 and lift cord 11 may pass through holes in the slats and also pass through gaps 10a formed between rungs of the ladder adjacent the cord shroud. For example, multiple rungs may extend between a pair of rails to support a portion of a slat 4. A gap 10a may be defined between these rungs. The lift cord and cord shroud may extend through a hole in the slat and also pass through the gap 10a.

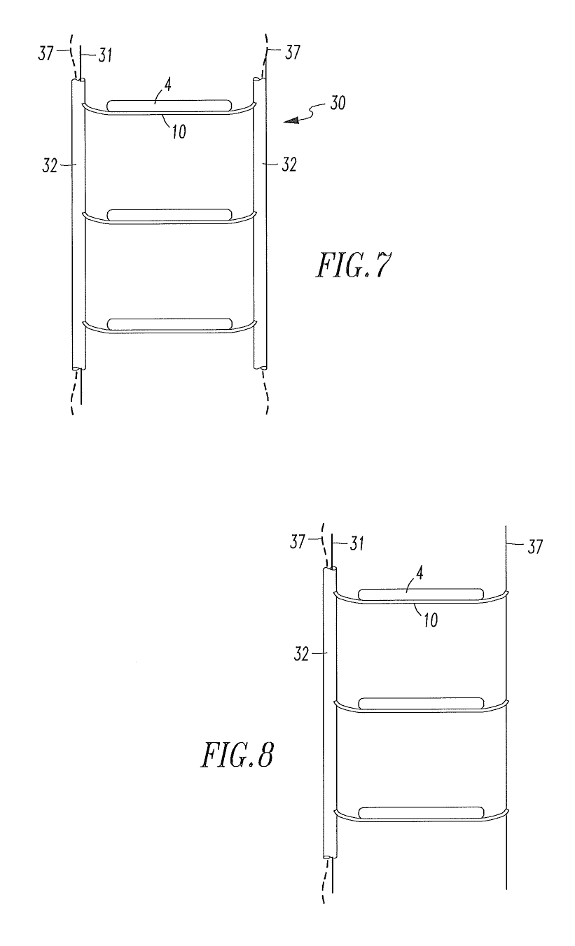

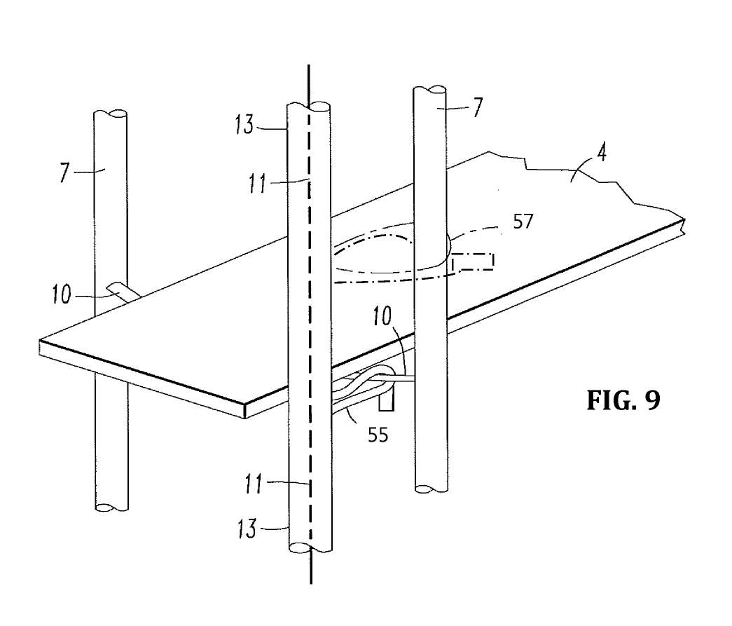

Referring to FIG. 7, it is also contemplated that ladders 30 of the blind may have rails that also function as cord shrouds. For instance, an embodiment of the blind may include slats 4 that are supported on rungs 10. The rungs 10 may extend between two rails. The rails may be tubular structures that have mesh surfaces that are capable of functioning as cord shrouds. A lift cord 31 may pass through one of the rails that functions as and is a cord shroud 32. In some embodiments, a second lift cord (not shown) may pass through the opposite rail that functions as a cord shroud as well. The cord shroud 32 may enclose a portion of the lift cord 31 that extends out of the headrail of a blind and to a bottom rail or lowermost slat while also being periodically attached to the ladder via the rungs 10 attached to the opposite rail. Such periodic attachment of the cord shroud to the opposite rail by the rungs can prevent the pulling away of the enclosed portion of the lift cord to form a dangerous loop.

In alternative embodiments it is contemplated that the ladders may include rails defined by cords 37 that pass through the cord shrouds 32 to form rails of the ladder that are attached to the rungs 10. For such an embodiment, the cord shrouds may cover a portion of respective ones of the lift cords 31 and also cover a portion of the rails 37.

Referring to FIG. 8, another alternative embodiment of my blind may include a ladder that only uses one cord shroud 32 that may either also function as a rail or, alternatively, may be positioned so that the cord shroud 32 covers both a lift cord 31 and a cord 37 that functions as a rail for a ladder. The rail opposite the cord shroud 32, however, may only be a cord 37. The cord shroud 32 may function as a rail of the ladder and be periodically attached to the rail 37 via the rungs 10 to prevent the lift cord enclosed by the cord shroud 32 from being pulled away form the slats to form a loop that may be dangerous to a small child.

Such an embodiment may be configured so that after the blind is mounted adjacent to a window, the cord shrouds are positioned adjacent the window on a rear side of the blind to hide the cord shrouds from view from a person in a room. The blind may then appear to the user in the room as a typical venetian blind while also providing the protection afforded by the cord shroud covering the lift cord and preventing the substantial pulling of lift cords away from the slats 4 that have the potential for leading to an occurrence of a dangerous child entanglement with such a pulled lift cord.

It should be appreciated that a blind may have any number of lift cords, ladders for supporting the slats, and cord shrouds. The number of lift cords, ladders, and cord shrouds used may depend on a number of design and aesthetic options, such as the size of the blind and the length and weight of the slats.

It should be appreciated that alternative lift cord control mechanisms may be utilized instead of a cord lock in other embodiments of the blind. For example, lift cord control mechanisms such as spring motor arrangements used in cordless shades, motors, or other lift cord control systems may be utilized in some embodiments of the blind.

While certain present preferred embodiments of the window covering and certain embodiments of methods of practicing the same have been shown and described, it is to be distinctly understood that the invention is not limited thereto but may be otherwise variously embodied and practiced within the scope of the following claims.

1. A blind comprising:
a headrail;
a plurality of ladders extending from the headrail each ladder comprised of a column of rungs extending between two spaced apart rails;
a plurality of slats supported on the ladders the plurality of slats comprising a lowermost slat which is positioned furthest from the headrail;
a plurality of lift cords extending from the headrail, each lift cord being adjacent to one of the plurality of ladders and extending to the lowermost slat; and
a plurality of cord shrouds, each of the cord shrouds enclosing a portion of one of the lift cords that extends from the headrail to a position adjacent to the lowermost slat and the cord shroud being attached to the ladder which is adjacent the lift cord enclosed by the cord shroud.

2. The blind of claim 1 wherein each of the cord shrouds is attached to a respective one of the ladders at spaced apart positions.

3. The blind of claim 1 wherein each of the cord shrouds is attached to at least one of the rails of a respective one of the ladders.

4. The blind of claim 1 further comprising a plurality of fasteners, each of the fasteners attaching one of the cord shrouds to one of the rails or one of the rungs.

5. The blind of claim 1 wherein the lift cords and cord shrouds extend through the slats.

6. The blind of claim 1 wherein the lift cords and cord shrouds extend adjacent to an edge of each of the slats.

7. The blind of claim 1 wherein each of the cord shrouds is attached to a respective one of the ladders by being attached to the rungs of a respective one of the ladders.

8. The blind of claim 7 wherein each of the cord shrouds is attached to each and every one of the rungs of the respective one of the ladders.

9. The blind of claim 1 further comprising a bottom rail, the portion of each of the lift cords extending to the bottom rail.

10. (canceled)

11. The blind of claim 1 wherein the ladders are comprised of cord material or strands of cord material.

12. The blind of claim 1 wherein each of the rails of the ladders is a flexible elongated member.

13. The blind of claim 1 wherein each of the cord shrouds is attached to a plurality of the rungs or at least one of the rails of a respective one of the ladders.

14. The blind of claim 1 wherein each of the cord shrouds and each of the lift cords extend through gaps defined between adjacent rungs of a respective one of the ladders.

15. The blind of claim 1 wherein each of the cord shrouds is attached to a respective one of the ladders at spaced apart locations such that spacing between immediately adjacent locations of attachment between the cord shroud and the ladder prevents the cord shroud from being pulled away from the slats to form a loop that is over six inches in diameter.

16. The blind of claim 1 wherein rings or loops extend from each of the cord shrouds to connect the cord shrouds to the ladders.

17. The blind of claim 16 wherein the loops are adjustable loops or zip ties.

18. The blind of claim 1 wherein each of the cord shrouds has a first end and a second end opposite the first end, the first end attached to the headrail and the second end attached to the lowermost slat.

19. The blind of claim 1 further comprising a bottom rail, the portion of each of the lift cords extending to the bottom rail and wherein each of the cord shrouds has a first end and a second end opposite the first end, the first end attached to the headrail and the second end attached to the bottom rail.

20-23. (canceled)
